(19) United States
(12) Patent Application Publication
(10) Pub. No.: US 2006/0239236 A1
(43) Pub. Date: Oct. 26, 2006

(54) Wireless communication apparatus, communication system and method of configuring wireless communication therein

(76) Inventor: Mitsuru Otsuka, Kawasaki-shi (JP)

Correspondence Address: MORGAN & FINNEGAN, L.L.P., 3 WORLD FINANCIAL CENTER, NEW YORK, NY, 10281-2101, US

(21) Appl. No.: 11/406,942

(22) Filed: Apr. 18, 2006

(30) Foreign Application Priority Data
Apr. 20, 2005 (JP) 2005-122949

(51) Int. Cl. H04L 12/28; H04Q 7/24

(52) U.S. Cl. 370/338; 370/254

(57) ABSTRACT

It is made possible to designate erasure or updating of the communication parameters. If configuration information of a party has not been stored in a storage unit, then the configuration information of the communicating party apparatus is requested, the configuration information transmitted from the communicating party in response to the request is stored in the storage unit, wireless communication with the communicating party apparatus is executed in accordance with the configuration information that has been stored in the storage unit, and a user interface is provided so that the user may indicate updating of the configuration information that has been stored in the storage unit.

### FIELD OF THE INVENTION

This invention relates to a wireless communication apparatus having a plurality of wireless communication methods and to a method of configuring wireless communication in this apparatus.

### BACKGROUND OF THE INVENTION

In a conventional communication apparatus that communicates wirelessly, wireless communication parameters for wireless communication are stored in each communication apparatus in order to harmonize wireless communication with communicating partners. Since such parameters for wireless communication become unnecessary when wireless communication ends, it is required that each communication apparatus be provided with an erase function for erasing the wireless communication parameters that have been stored. As examples of such an erase function, the specification of Japanese Patent Application Laid-Open No. 09-282561 discloses a technique in which an interruption in supplied power is investigated and parameters are erased when a preset period of time elapses. Further, the specification of US Laid-Open No. 2005015467 (Japanese Patent Application Laid-Open No. 2003-229872) discloses a technique in which wireless communication parameters are stored using short-distance wireless communication such as a contactless IC interface. The wireless communication apparatus does not possess a mechanism for erasing the stored wireless communication parameters. Further, the specification of US Laid-Open No. 2005272371 (Japanese Patent Application Laid-Open No. 2004-007351) discloses a technique in which wireless communication parameters are stored using short-distance wireless communication such as a contactless IC interface. Disclosed is a technique for holding or erasing communication parameters in accordance with information indicating whether the holding of the parameters is permitted or not.

The conventional techniques for storing wireless communication parameters using short-distance wireless communication such as a contactless IC interface have a number of problems. First, if communication parameters necessary to perform one-on-one adhoc wireless communication with a plurality wireless communication units have been stored, which communication parameter is to be erased or updated cannot be specified. Second, if a plurality of communication parameters have been stored, there is no mechanism that allows selection of wireless communication using a particular communication parameter.

### SUMMARY OF THE INVENTION

Accordingly, an object of the present invention is to solve the aforementioned problems of the prior art.

Another object of the present invention is to provide a wireless communication apparatus, communication system and wireless communication configuration method whereby configuration information for wireless communication can be readily updated.

The present invention comprises constitution following as an exclusive step achieving the foregoing objects.

A communication system for performing communication wirelessly between a first wireless communication apparatus and a second wireless communication apparatus, comprising an acquisition unit for causing device information concerning the second wireless communication apparatus to be acquired by the first wireless communication apparatus, a memory unit for storing configuration information, which is for the purpose of wireless communication, in correspondence with the device information concerning the second wireless communication apparatus, a wireless communication unit for executing communication wirelessly between the first wireless communication apparatus and the second wireless communication apparatus in accordance with the configuration information that has been stored in the memory unit, and an indication unit for indicating to update or erase the configuration information that has been stored in the memory unit in correspondence with the device information acquired by the acquisition unit.

It should be noted that the description of the present invention does not set forth all of the necessary features. Accordingly, combinations of these features are also covered by the present invention.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a block diagram illustrating the structure of a wireless communication apparatus according to an embodiment of the present invention;

FIG. 2 is a conceptual view of operation when two wireless communication apparatus having the structure shown in FIG. 1 transmit configuration information using an NFC interface;

FIG. 3 is a conceptual view of operation when two wireless communication apparatus having the structure shown in FIG. 1 transmit configuration information using an NFC interface;

FIG. 4 is a diagram illustrating a sequence for an exchange of device information between a providing device and an acquiring device, as well as example of device information transmitted from the providing device to the acquiring device, in accordance with the embodiment;

FIG. 5 is a diagram illustrating a sequence for an exchange of configuration information between a providing device and an acquiring device, as well as example of configuration information transmitted from the providing device to the acquiring device, in accordance with the embodiment;

FIG. 6 is a diagram illustrating an example of configuration information stored in correspondence with device information in a configuration information storage unit of an acquiring device according to this embodiment;

FIG. 7 is a diagram illustrating an example of a user interface of an acquiring device in this embodiment;

FIG. 8 is a diagram useful in describing an operation sequence in a case where configuration information corresponding to device information of a providing device has not been stored in a configuration information storage unit of an acquiring device in this embodiment;

FIG. 9 is a diagram useful in describing an operation sequence in a case where configuration information corresponding to device information of a providing device has been stored in a configuration information storage unit of an acquiring device and an indication to erase this configuration information has been made using a user interface in this embodiment;

FIG. 10 is a diagram useful in describing an operation sequence in a case where configuration information corresponding to device information of a providing device has been stored in a configuration information storage unit of an acquiring device and an indication to update this configuration information has been made using a user interface in this embodiment;

FIG. 11 is a flowchart useful in describing processing for acquiring configuration information in an acquiring device in this embodiment;

FIG. 12 is a flowchart useful in describing processing for erasing or updating configuration information in an acquiring device in this embodiment; and

FIG. 13 is a flowchart useful in describing operation in a providing device according to this embodiment.

### DETAILED DESCRIPTION OF THE PREFERRED EMBODIMENT

A preferred embodiment of the present invention will now be described in detail with reference to the accompanying drawings. It should be noted that the embodiment below does not limit the present invention set forth in the claims and that not all of the combinations of features described in the embodiment are necessarily essential as means for attaining the objects of the invention.

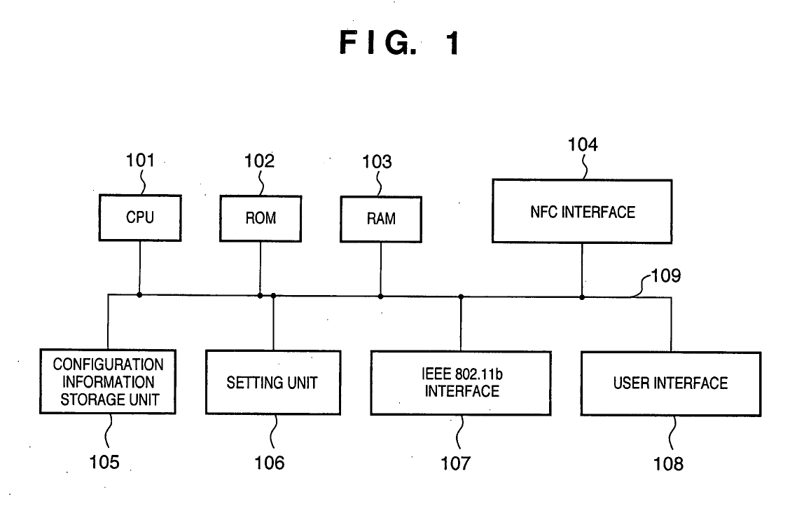

FIG. 1 is a block diagram illustrating the structure of a wireless communication apparatus according to an embodiment of the present invention.

The wireless communication apparatus has a CPU 101 for controlling the operation of the overall apparatus, a ROM 102 for storing a control program, which is executed by the CPU 101, and various data, and a RAM 103, which is used as a work area of the CPU 101 and stores various data. An NFC (Near Field Communication) interface 104 generates an electromagnetic field that makes communication possible only over short distances and performs communication wirelessly. A wireless configuration information storage unit (referred to as a “configuration information storage unit”) 105 stores various configuration information for wireless communication, this information including parameters necessary for wireless communication. A wireless configuration information setting unit (referred to as a “setting unit”) 106 sets the wireless-communication configuration information (referred to as “configuration information” below), which has been stored in the configuration information storage unit 105, to an interface 107 compliant with IEEE 802.11b. The IEEE 802.11b interface 107 controls communication in accordance with a protocol that is compliant with IEEE 802.11b, which is one wireless LAN standard. A user interface 108, which has a display and a control panel, presents messages to the user and processes user inputs. A bus 109 is a system bus that connects the components mentioned above.

A typical example of the NFC interface 104 is a contactless IC interface comprising a combination of a contactless IC card and reader/writer such as disclosed in the specifications of Japanese Patent Application Laid-Open Nos. 2003-229872 and 2004-007351 cited above.

Described next will be a case where configuration information is transmitted between two wireless communication apparatus, which have the structure set forth above, using respective ones of NFC interfaces 104 thereof.

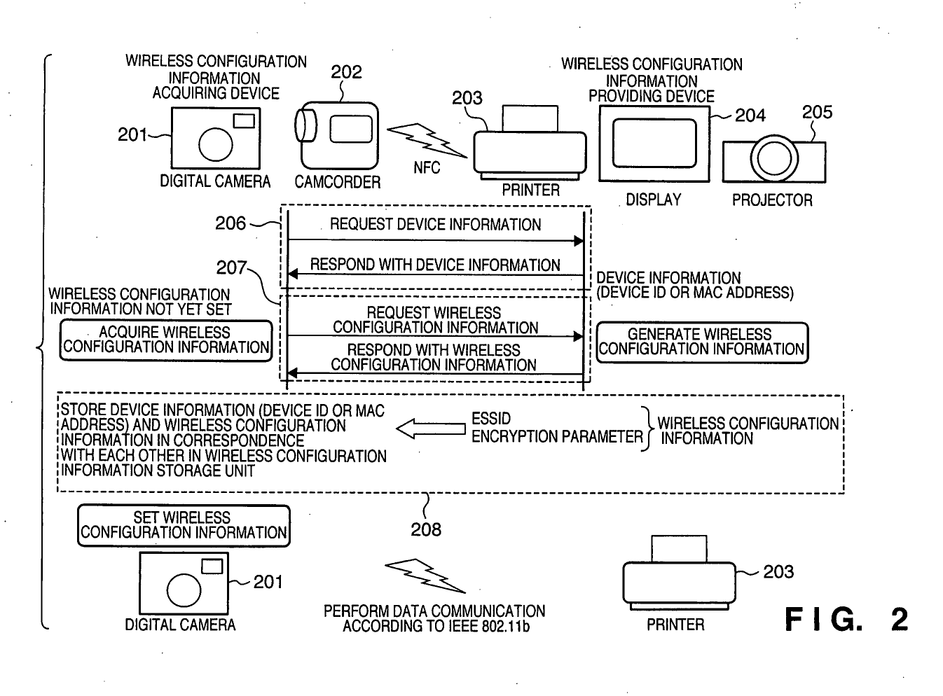

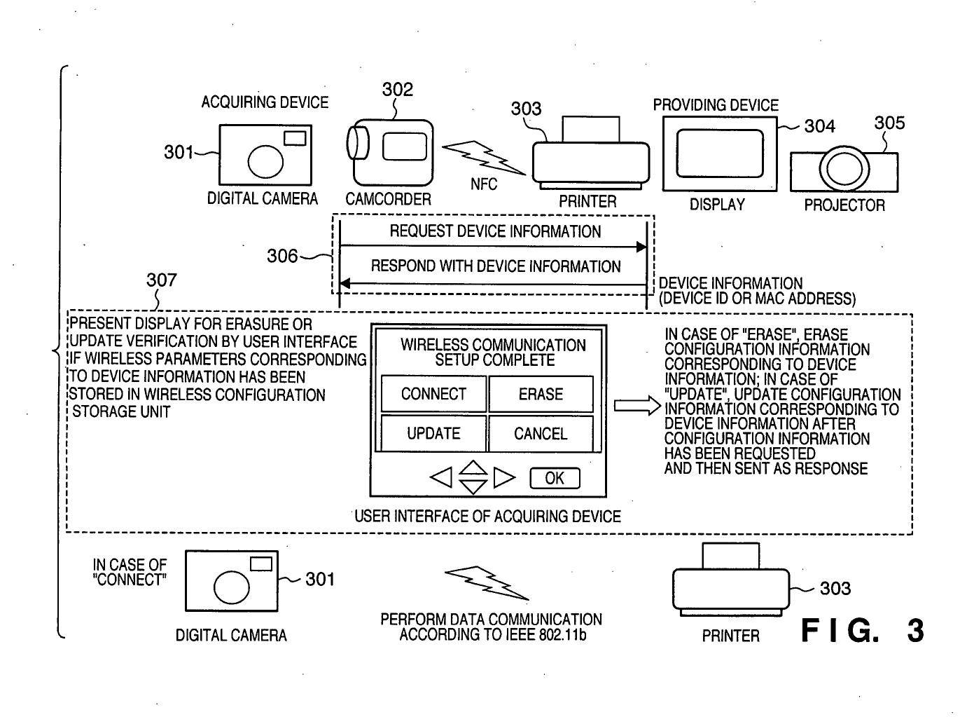

FIGS. 2 and 3 are conceptual views of operation when two wireless communication apparatus having the structure shown in FIG. 1 transmit configuration information using their NFC interfaces 104.

Configuration information is transmitted using the NFC interface 104 in FIG. 2. A digital camera 201 and a camcorder 202 are illustrated as acquiring devices that acquire this configuration information. A printer 203, display 204 and projector 205 are illustrated as examples of providing devices that generate configuration information and transmit this information to the acquiring devices.

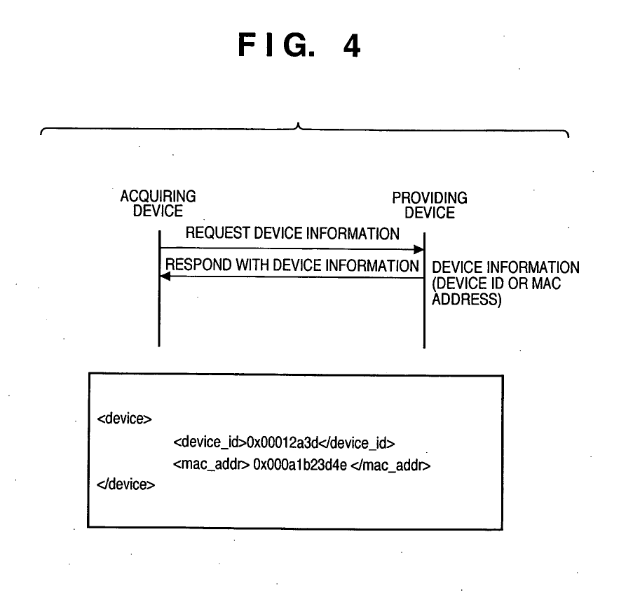

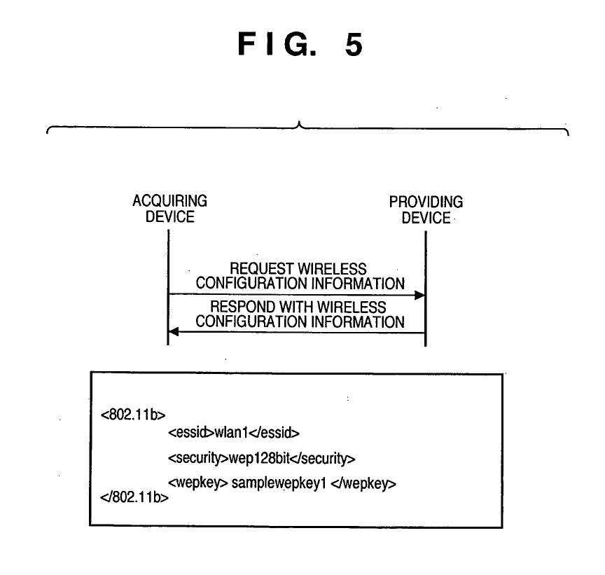

Reference numerals 206 and 207 denote a sequence according to which device information is sent and received using the NFC interface 104 and a sequence according to which configuration information is sent and received using the 104, respectively. The details of these sequences will be described later with reference to FIGS. 4 and 5. According to sequence 206, an acquiring device requests a providing device for device information concerning the providing device, and the providing device responds by transmitting the device information to the acquiring device. The device information includes the device ID of the providing device or the MAC address of the IEEE 802.11b interface 107.

According to sequence 207, when an acquiring device requests a providing device for configuration information, the providing device responds by generating the configuration information and transmitting the generated configuration information to the acquiring device. Further, according to sequence 207, a providing device generates configuration information composed of an ESSID, which is a network identifier, and an encryption parameter, and transmits the configuration information to the acquiring device. As a result, the acquiring device stores the device information and configuration information in association with each other in the configuration information storage unit 105 (208). It should be noted that the operating concept illustrated in FIG. 2 is implemented in a case where configuration information corresponding to device information has not been stored in the configuration information storage unit 105 of the acquiring device.

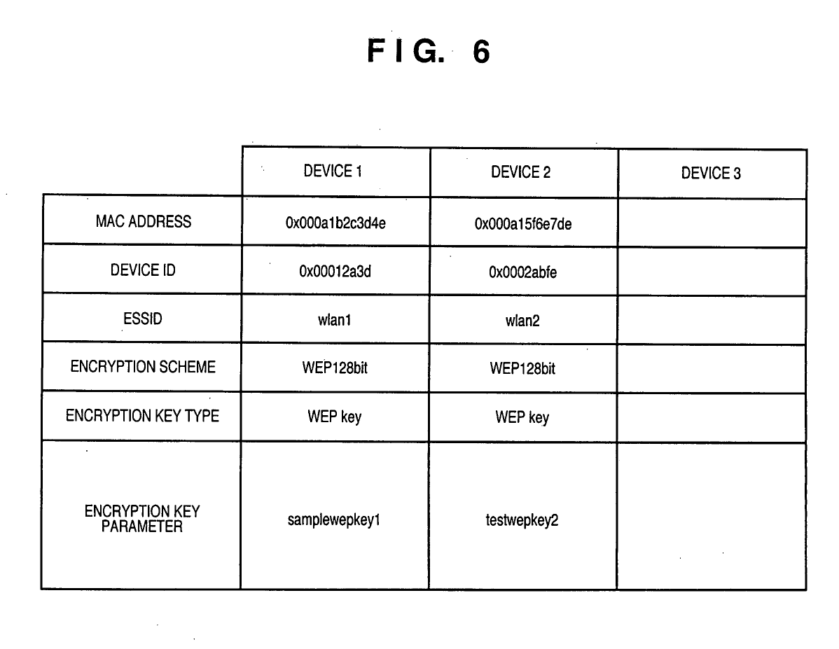

An example in which items of device information and configuration information are associated and stored in the configuration information storage unit 105 will be described later with reference to FIG. 6. When configuration information is thus set in the setting unit 106 of the acquiring device and in the setting unit 106 of the providing device, data communication is performed from this point onward by adhoc communication according to IEEE 802.11b via the IEEE 802.11b interface 107. FIG. 2 illustrates an example in which data communication is performed according to IEEE 802.11b in a case where the acquiring device is the digital camera 201 and the providing device is the printer 203.

Configuration information is transmitted using the NFC interface 104 in FIG. 3 in a manner similar to that of FIG. 2. Here a digital camera 301 and a camcorder 302 are illustrated as acquiring devices that acquire this configuration information. A printer 303, display 304 and projector 305 exemplify providing devices that generate configuration information and transmit this information to the acquiring devices in response to a request from an acquiring device. These are similar to the digital camera 201, camcorder 202, printer 203, display 204 and projector 205, respectively, in FIG. 2.

Indicated at 306 is a sequence according to which device information is sent and received using the NFC interface 104. According to this sequence, an acquiring device requests a providing device for device information, and the providing device responds by transmitting the device information of the providing device to the acquiring device. The device information includes the device ID of the providing device or the MAC address of the IEEE 802.11b interface 107.

The operating concept illustrated in FIG. 3 is for a case where configuration information corresponding to device information has been stored in the configuration information storage unit 105 of the acquiring device. In a case where configuration information corresponding to device information concerning a providing device has already been stored in the configuration information storage unit 105 of an acquiring device, verification 307 of erasure or updating of configuration information by the user interface 108 is performed or wireless communication between a providing device and acquiring device is started using this configuration information.

Here a user interface (UI) screen which, based upon the configuration information, is for designating “CONNECT” processing, “ERASE” for erasing configuration information, “UPDATE” for updating configuration information or “CANCEL” for canceling the designating operation, is displayed on the user interface 108 of the acquiring device, and processing corresponding to the item selected by the user employing this UI screen is executed. If “CONNECT” has been selected, the acquiring device and providing device authenticate each other and are organically interconnected in accordance with already set configuration information corresponding to the device information, and wireless data communication compliant with IEEE 802.11b is carried out. If “ERASE” has been selected, configuration information that has been stored in the configuration information storage unit 105 of the acquiring device in correspondence with the device information is erased and the setting of wireless communication in the setting unit 106 is cancelled. If “UPDATE” has been selected, then, in a manner similar to that of the configuration information sequence 207 in FIG. 2, processing of transmission and reception, which is for requesting a providing device for configuration information and receiving the response, is executed using the NFC interface 104. Thus, by using newly acquired configuration information, the acquiring device updates the configuration information that has been stored in the configuration information storage unit 105 in correspondence with the device information. The updated configuration information is set in the setting unit 106 and, from this point onward, data communication compliant with IEEE 802.11b is performed between the acquiring device and providing device based upon the configuration information that has been updated.

FIG. 4 is a diagram illustrating a sequence for sending and receiving device information between a providing device and an acquiring device, as well as example of device information transmitted from the providing device to the acquiring device.

Device information is composed of the device ID or the MAC address of the IEEE 802.11b interface 107, as mentioned above. FIG. 4 illustrates an example in which the device information is composed of tagged text. The device ID (here “0x00012a3d) is indicated by the tag “<device_id>, and the MAC address (here “0x000a0b2c3d4e”) is indicated by the tag “<mac_addr>”. FIG. 4 illustrates an example including both a device ID and MAC address.

FIG. 5 is a diagram illustrating a sequence for sending and receiving configuration information between a providing device and an acquiring device, as well as an example of configuration information transmitted from the providing device to the acquiring device. Here as configuration information, parameters that are necessary for wireless communication on IEEE 802.11b interface 107 are transmitted.

FIG. 5 illustrates an example in which the configuration information is composed of tagged text. Specifically, ESSID (here “wlan1”) is indicated by the tag “<essid>” and the encryption scheme (“wep128 bit”) is indicated by the tag “<security>”. Furthermore, an encryption key parameter (Here “samplewepkey1”) is indicated by the tag “<wepkey>”.

FIG. 6 is a diagram illustrating an example of configuration information stored in correspondence with device information in the configuration information storage unit 105 of an acquiring device. Here configuration information corresponding to device information of two providing devices (devices 1 and 2) has been stored.

Parameters (“0x000a1b2c3d4e” and “0x00012a3d”) necessary in order to perform wireless communication adhoc with the IEEE 802.11b interface of device 1 have been stored as the MAC address and device ID, respectively, of device 1. Furthermore, ESSID is “wlan1”, the encryption scheme is “WEP128 bit”, the encryption key type is “WEPkey” and the encryption key parameter is “samplewepkey1” for device 1.

Further, parameters (“0x000a15f6e7de” and “0x0002abfe”) necessary in order to perform wireless communication adhoc with the IEEE 802.11b interface of device 2 have been stored as the MAC address and device ID, respectively, of device 2. Furthermore, ESSID is “wlan2”, the encryption scheme is “WEP128 bit”, the encryption key type is “WEPkey” and the encryption key parameter is “testwepkey1”.

Thus, an acquiring device that requires configuration information can acquire the configuration information from a providing device using the NFC interface 104. The configuration information thus acquired is stored in the configuration information storage unit 105 of the acquiring device. As a result, configuration information of a device (providing device) that is capable of being connected to the acquiring device by wireless communication is stored in the configuration information storage unit 105 of the acquiring device.

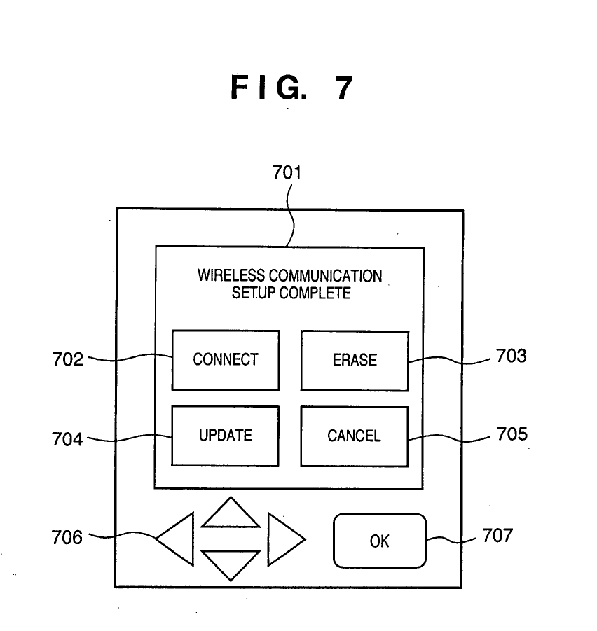

FIG. 7 is a diagram illustrating an example of the user interface 108 of an acquiring device in this embodiment.

In a case where configuration information corresponding to device information has already been stored in the configuration information storage unit 105 of an acquiring device, text reading “WIRELESS COMMUNICATION SETUP COMPLETE” is displayed on a display unit 701 of the user interface 108. The following items are displayed on the display unit 701: a “CONNECT” button 702 to instruct that this acquiring device and a providing device (which corresponding to the device information) are to be connected organically using the already set configuration information corresponding to the device information; an “ERASE” button 703 to instruct that the already set configuration information corresponding to the device information is to be erased from the configuration infomation storage unit 105 of this acquiring device; an “UPDATE” button 704 to instruct that the configuration information that has been stored in the configuration information storage unit 105 of the acquiring device in correspondence with the device information is to be updated by configuration information newly transmitted from the providing device (which corresponds to the device information); and a “CANCEL” button 705 for canceling NFC communication without executing processing to erase or update the configuration information. The processing corresponding to each of the buttons is started by selecting any of the “CONNECT”, “ERASE”, “UPDATE”, “CANCEL” buttons by direction keys 706 indicating up, down, left and right, and designating (pressing) an OK button 707. The processing corresponding to these buttons is as described above.

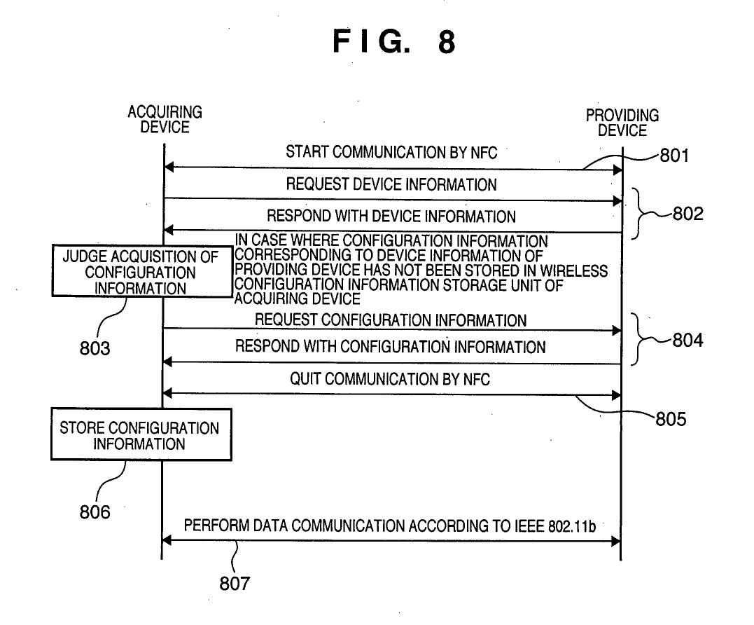

FIG. 8 is a diagram useful in describing an operation sequence in a case where configuration information corresponding to device information of a providing device has not been stored in the configuration information storage unit 105 of an acquiring device in this embodiment.

In FIG. 8, reference numeral 801 denotes start of communication between an acquiring device and a providing device via the NFC interface 104. Reference numeral 802 denotes a procedure through which the acquiring device requests the providing device for device information and acquires the device information from the providing device. At reference numeral 803, the acquiring device determines whether configuration information corresponding to the device information of the providing device has been stored and, if the configuration information has not been stored, requests the providing device for the configuration information. The configuration information is transmitted from the providing device to the acquiring device in response to this response (804). When acquisition of the configuration information in the acquiring device is thus completed, communication via the NFC interface 104 ends (805). Next, at 806, the acquiring device stores the acquired configuration information in the configuration information storage unit 105. Wireless communication via the IEEE 802.11b interface is thenceforth carried out between the acquiring device and providing device (807).

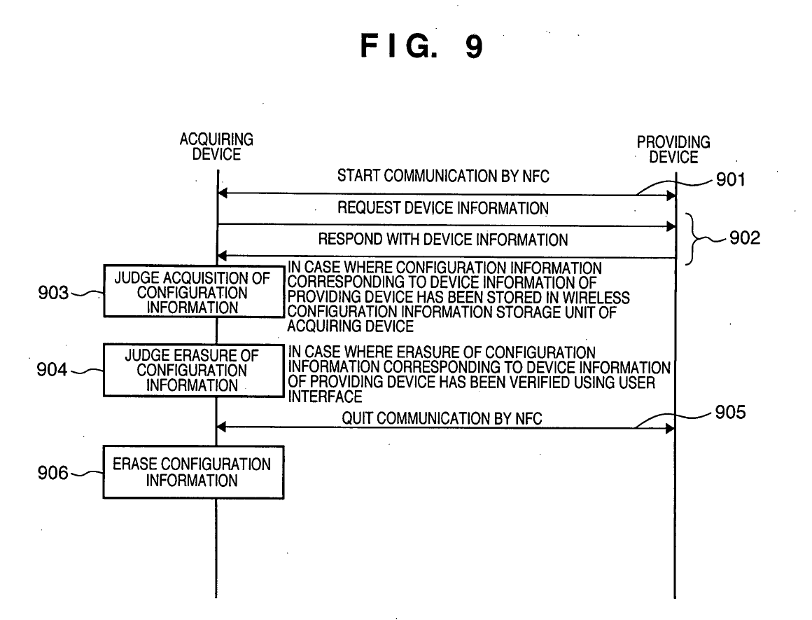

FIG. 9 is a diagram useful in describing an operation sequence in a case where configuration information corresponding to device information of a providing device has been stored in the configuration information storage unit 105 of an acquiring device and an indication to erase this configuration information has been made using the user interface 108.

In FIG. 9, reference numeral 901 denotes start of communication between an acquiring device and a providing device via the NFC interface 104. Reference numeral 902 denotes a procedure through which the acquiring device requests the providing device for device information and acquires the device information from the providing device. At reference numeral 903, the acquiring device determines whether configuration information corresponding to the device information of the providing device has been stored in the configuration information storage unit 105. Since the configuration information has been stored in this case, the UI screen shown in FIG. 7 is displayed on the display unit 701. If “ERASE” 703 is designated at 904, then communication via the NFC interface 104 is terminated at 905 and the configuration information that has been designated is erased from the configuration information storage unit 105.

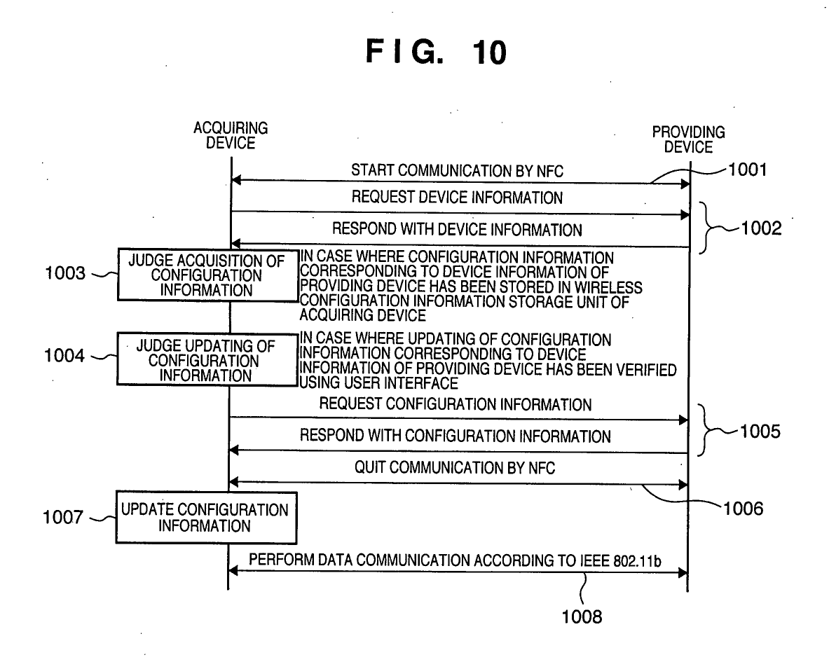

FIG. 10 is a diagram useful in describing an operation sequence in a case where configuration information corresponding to device information of a providing device has been stored in the configuration information storage unit 105 of an acquiring device and an indication to update this configuration information has been made using the user interface 108 in this embodiment.

In FIG. 10, reference numeral 1001 denotes start of communication between an acquiring device and a providing device via the NFC interface 104. Reference numeral 1002 denotes a procedure through which the acquiring device requests the providing device for device information and acquires the device information from the providing device. At reference numeral 1003, the acquiring device determines whether configuration information corresponding to the device information of the providing device has been stored. Since the configuration information has been stored in this case, the UI screen shown in FIG. 7 is displayed on the display unit 701. If “UPDATE” is designated at 1004, then the acquiring device requests the providing device for configuration information. In response, the providing device transmits the configuration information to the acquiring device (1005). When acquisition of the configuration information in the acquiring device ends, communication via the NFC interface 104 ends (1006). The acquiring device achieves updating by storing the acquired configuration information in the configuration information storage unit 105. Wireless communication via the IEEE 802.11b interface is thenceforth performed between the acquiring device and providing device (1008).

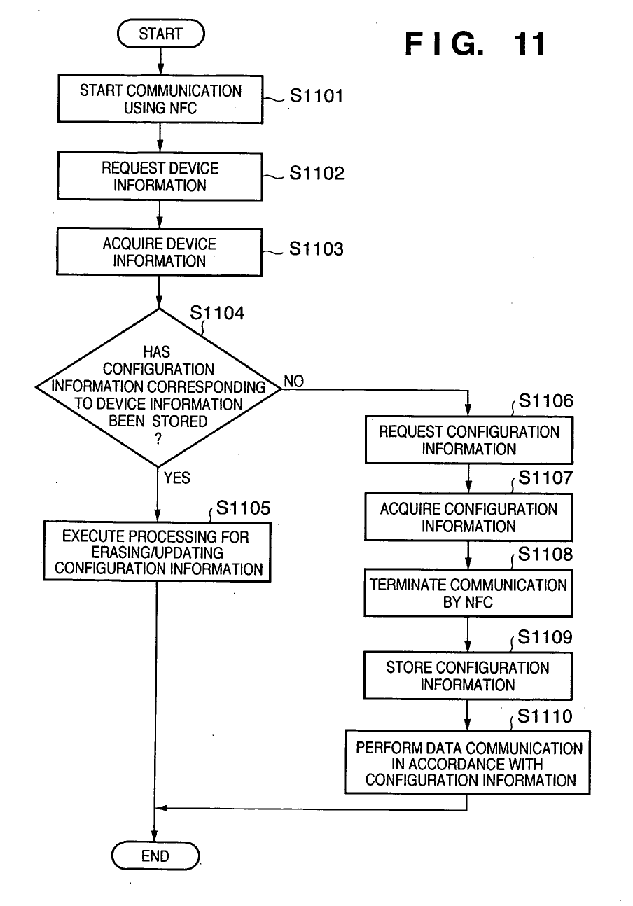

FIG. 11 is a flowchart useful in describing processing for acquiring configuration information in an acquiring device in this embodiment. The program for executing this processing is stored in the ROM 102 and is executed under the control of the CPU 101.

First, at step S1101, communication using the NFC interface 104 is started by bringing the acquiring device close to the providing device. This operation corresponds to “START COMMUNICATION BY NFC” at 801, 901 and 1001 in the operation sequences of FIGS. 8 to 10.

Next, at step S1102, a message requesting device information is transmitted from the acquiring device to the providing device and, in response, the acquiring device acquires the device information from the providing device (step S1103). This operation corresponds to “REQUEST DEVICE INFORMATION” and “RESPOND WITH DEVICE INFORMATION” (802, 902, 1002) in the operation sequences of FIGS. 8 to 10.

Next, at step S1104, it is determined whether configuration information corresponding to the device information acquired from the providing device has been stored in the configuration information storage unit 105. If configuration information corresponding to the device information has been stored, control proceeds to step S1105 and the screen illustrated in FIG. 7 is displayed on the user interface 108. If “ERASE” or “UPDATE”, etc., of the configuration information is designated using this screen, the corresponding processing is executed. This corresponds to the processing 904, 906 of FIGS. 9 and 10 and the processing of 1004 to 1007 of FIG. 10. It should be noted that if “CONNECT” is designated in FIG. 7, then data communication via the IEEE 802.11b interface 107, as indicated at 807 and 1008, begins.

On the other hand, when it is determined at step S1104 that configuration information has not been stored, then control proceeds to step S1106 and a message requesting configuration information is transmitted from the acquiring device to the providing device by communication using the NFC interface 104. Configuration information transmitted from the providing device in response is received and the configuration information is acquired at step S1107. This operation corresponds to “REQUEST CONFIGURATION INFORMATION” and “RESPOND WITH CONFIGURATION INFORMATION” in operating sequence 804 of FIG. 8.

Next, at step S1108, communication using the NFC interface 104 is terminated. This operation corresponds to “QUIT COMMUNICATION BY NFC” at 805 in the operation sequence of FIG. 8. This is followed by step S1109, at which the configuration information acquired from the providing device is stored in the configuration information storage unit 105. This operation corresponds to “STORE CONFIGURATION INFORMATION” at 806 in the operation sequence of FIG. 8. Then, at step S1110, the configuration information that has been stored in the configuration information storage unit 105 is set in the setting unit 106 and data communication via the IEEE 802.11b interface 107 is started. This operation corresponds to “PERFORM DATA COMMUNICATION ACCORDING TO IEEE 802.11b” at 807 in the operation sequence of FIG. 8.

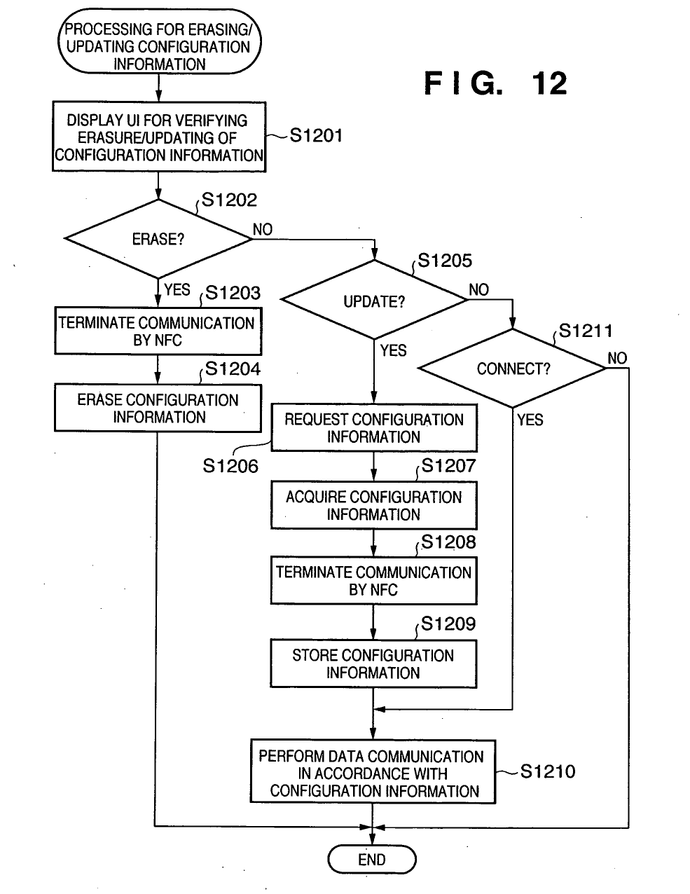

FIG. 12 is a flowchart useful in describing processing for erasing or updating configuration information in an acquiring device in this embodiment. The program for executing this processing is stored in the ROM 102 and is executed under the control of the CPU 101.

First, at step S1201, the screen (FIG. 7) for verifying erasure or updating of configuration information that has been stored in the configuration information storage unit 105 of an acquiring device is displayed on the user interface 108 of the acquiring device. Next, at step S1202, it is determined whether an indication to erase configuration information that has been stored in the configuration information storage unit 105 of the acquiring device has been made using the user interface 108 of the acquiring device. In other words, it is determined whether the “ERASE” button 703 has been designated. Control proceeds to step S1203 when an indication to erase the configuration information has been made, and to step S1205 when an indication to erase the configuration information has not been made. This operation corresponds to “JUDGE ERASURE OF CONFIGURATION INFORMATION” at 904 in the operation sequence of FIG. 9.

Communication using the NFC interface 104 is terminated at step S1203. This operation corresponds to “QUIT COMMUNICATION BY NFC” at 905 in the operation sequence of FIG. 9. Next, at step S1204, the configuration information that has been stored in the configuration information storage unit 105 of the acquiring device is erased and processing for erasing the configuration information is quit after the settings of the setting unit 106 of the acquiring device are cancelled. This operation corresponds to “ERASE CONFIGURATION INFORMATION” at 906 in the operation sequence of FIG. 9.

On the other hand, when an indication to erase configuration information has not been made at step S1202, control proceeds to step S1205 and it is determined whether an indication to update the configuration information that has been stored in the configuration information storage unit 105 of the acquiring device has been made using the user interface 108 (FIG. 7) of the acquiring device. Control proceeds to step S1206 when an indication to update the configuration information has been made, and to step S1211 when an indication to update the configuration information has not been made. This operation corresponds to “JUDGE UPDATING OF CONFIGURATION INFORMATION” at 1004 in the operation sequence of FIG. 10. A message requesting configuration information is transmitted to the providing device by communication using the NFC interface 104 at step S1206, and configuration information transmitted from the providing device in response to this request is received and acquired at step S1207. This operation corresponds to “REQUEST CONFIGURATION INFORMATION” and “RESPOND WITH CONFIGURATION INFORMATION” at 1005 in the operation sequence of FIG. 10. Next, at step S1208, communication using the NFC interface 104 is terminated. This operation corresponds to “QUIT COMMUNICATION BY NFC” at 1006 in the operation sequence of FIG. 10. This is followed by step S1209, at which the configuration information acquired from the providing device is stored at a location in the configuration information storage unit 105 that corresponds to the device information acquired from the providing device. This operation corresponds to “UPDATE CONFIGURATION INFORMATION” at 1007 in the operation sequence of FIG. 10. Then, at step S1210, the configuration information that has been stored in the configuration information storage unit 105 is set in the setting unit 106 and data communication via the IEEE 802.11b interface 107 is started. This operation corresponds to “PERFORM DATA COMMUNICATION ACCORDING TO IEEE 802.11b” at 1008 in the operation sequence of FIG. 10.

On the other hand, when “UPDATE” has not been indicated at step S1205, control proceeds to step S1211. Here it is determined whether an indication to connect to the providing device via the IEEE 802.11b interface 107 has been made, using the user interface 108 of the acquiring device, in accordance with the configuration information that has been stored in the configuration information storage unit 105 of the acquiring device. In other words, it is determined whether the “CONNECT” button 702 has been designated. When an indication to connect to the providing device by the IEEE 802.11b interface 107 has been made, control proceeds to step S1210 and data communication via the IEEE 802.1.1b interface 107 is started. Processing is exited when an indication to connect to the providing device by the IEEE 802.11b interface 107 has not been made at step S1211.

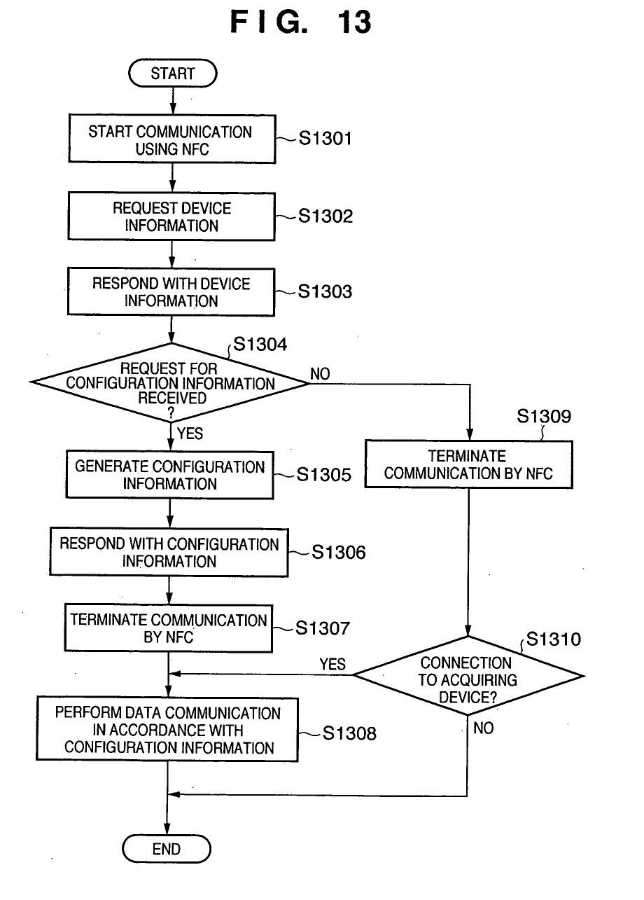

FIG. 13 is a flowchart useful in describing operation in a providing device according to this embodiment. The program for executing this processing is stored in the ROM 102 and is executed under the control of the CPU 101.

First, at step S1301, communication using the NFC interface 104 is started by bringing the acquiring device close to the providing device. This operation corresponds to “START COMMUNICATION BY NFC” at 801, 901 and 1001 in the operation sequences of FIGS. 8 to 10. Next, at step S1302, a message requesting device information is transmitted from the acquiring device to the providing device by communication using the NFC interface 104. In response, the device information is transmitted from the providing device to the acquiring device at step S1303. This operation corresponds to “REQUEST DEVICE INFORMATION” and “RESPOND WITH DEVICE INFORMATION” (802, 902, 1002) in the operation sequences of FIGS. 8 to 10.

Next, at step S1304, it is determined whether a message requesting configuration information has been received from the acquiring device by communication using the NFC interface 104. If a request for configuration information has been received from the acquiring device, control proceeds to step S1305. Here the configuration information is generated by the configuration information storage unit 105 of the providing device and this information is stored in the configuration information storage unit 105 in correspondence with the device information of this providing device. Next, at step S1306, the configuration information that has been stored in the configuration information storage unit 105 of this providing device is read out and is transmitted to the acquiring device, which requested the configuration information at step S1304, by a configuration-information response message. This operation corresponds to “RESPOND WITH CONFIGURATION INFORMATION” at 804, 1005 in the operation sequence of FIGS. 8 and 10. Communication using the NFC interface 104 is then terminated at step S1307. This operation corresponds to “QUIT COMMUNICATION BY NFC” at 805, 1006 in the operation sequence of FIG. 8. Then, at step S1308, the configuration information that has been stored in the configuration information storage unit 105 is set in the setting unit 106 and data communication via the IEEE 802.11b interface 107 takes place from this point onward. This operation corresponds to “PERFORM DATA COMMUNICATION ACCORDING TO-IEEE 802.11b” at 807, 1008 in the operation sequences of FIGS. 8a and 10.

On the other hand, if it is determined at step S1304 that a message requesting configuration information has not been received from the acquiring device, control proceeds to step S1309 and communication using the NFC interface 104 is terminated. Next, at step S1310, it is determined whether there is a connection by the IEEE 802.11b interface 107 to the acquiring device set in the setting unit 106 by the configuration information that has been stored in the configuration information storage unit 105. Here the providing device waits for the connection for a prescribed period of time and, if there is a connection from the acquiring device, then control proceeds to step S1308 and the above-described processing is executed. If there is no connection from the acquiring device, then the providing device terminates processing as is.

In accordance with the present invention, updating of configuration information for wireless communication can be facilitated.

In the description rendered above, NFC is used as the short-distance wireless communication scheme. However, infrared communication, Bluetooth and UWB (Ultra-Wide Band) can also be used as short-distance wireless communication schemes besides NFC.

Further, although IEEE 802.11b is used as the wireless communication scheme for transmitting and setting the parameters, which are necessary for wireless communication, as the configuration information, it is possible to employ other existing communication schemes, or communication schemes that may be standardized in the future, that are capable of transmitting and setting wireless communication parameters as configuration information over communication distances of dozens of meters.

Furthermore, in the description rendered above, WEP (Wired Equivalent Privacy) is used as the encryption scheme for encrypting wireless communication. However, it is also possible to use other existing encryption schemes or encryption schemes that may be standardized in the future.

### Other Embodiment

Note that the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy® disk, a hard disk, an optical disk (CD-ROM, DVD-ROM), a magneto-optical disk, a magnetic tape, a non-volatile type memory card, and a ROM.

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the claims.

This application claims the benefit of Japanese Application No. 2005-122949 filed Apr. 20, 2005, which is hereby incorporated by reference herein in its entirety.

What is claimed is:

1. A communication system for performing communication wirelessly between a first wireless communication apparatus and a second wireless communication apparatus, comprising:
an acquisition unit for causing device information concerning the second wireless communication apparatus to be acquired by the first wireless communication apparatus;
a memory unit for storing configuration information, which is for the purpose of wireless communication, in correspondence with the device information concerning the second wireless communication apparatus;
a wireless communication unit for executing communication wirelessly between the first wireless communication apparatus and the second wireless communication apparatus in accordance with the configuration information that has been stored in said memory unit; and
an indication unit for indicating to update or erase the configuration information that has been stored in said memory unit in correspondence with the device information acquired by said acquisition unit.

2. A communication system for performing communication wirelessly with a wireless communication apparatus, comprising:
a memory unit for storing configuration information, which is for the purpose of wireless communication, in correspondence with device information concerning the wireless communication apparatus;
a requesting unit which, in a case where configuration information of a communicating party in wireless communication has not been stored in said memory unit, is for requesting configuration information of the wireless communication apparatus of the communicating party;
a unit for storing the configuration information, which has been transmitted from the communicating party, in said memory unit in response to the request by said requesting unit;
a wireless communication control unit for executing communication wirelessly with the wireless communication apparatus of the communicating party in accordance with the configuration information that has been stored in said memory unit;
an acquisition unit for acquiring device information concerning the wireless communication apparatus of the communicating party from said communicating party; and
an indication unit for indicating to update or erase the configuration information that has been stored in said memory unit in correspondence with the device information acquired by said acquisition unit.

3. A communication apparatus for performing communication wirelessly with a wireless communication apparatus, comprising:
a memory unit for storing configuration information, which is for the purpose of wireless communication, in correspondence with device information concerning another wireless communication apparatus;
an acquisition unit for acquiring device information concerning the other wireless communication apparatus from this other wireless communication apparatus; and
an indication unit for indicating to update or erase the configuration information that has been stored in said memory unit in correspondence with the device information acquired by said acquisition unit.

4. The apparatus according to claim 3, wherein said acquisition unit acquires device information concerning a communicating party by a first communication scheme; and
the configuration information for the purpose of wireless communication is information for performing wireless communication by a second communication scheme.

5. The apparatus according to claim 3, further comprising a requesting unit which, in a case where configuration information corresponding to the device information acquired by said acquisition unit has not been stored in said memory unit, is for requesting the other wireless communication apparatus for the configuration information.

6. The apparatus according to claim 4, wherein the first communication scheme is any of Near Field Communication, which is a standard used in a contactless IC card interface, infrared communication, Bluetooth or Ultra-Wide Band; and
the second communication scheme is a scheme compliant with IEEE 802.11 related standard.

7. A wireless communication apparatus comprising:
a determination unit for determining, based upon identification information of a communicating party acquired by wireless communication by a first scheme, whether configuration information, which is for communicating wirelessly with the communicating party by a second scheme, has been stored; and
a display unit for presenting a display that conforms to the determination made by said determination unit;
wherein said display unit displays selectably at least any one of an indication to erase configuration information that corresponds to the communicating party, an indication to communicate wirelessly with the communicating party by the second scheme or an indication to update configuration information for communicating wirelessly with the communicating party by the second scheme.

8. A method of setting up wireless communication in a communication system for performing communication wirelessly between a first wireless communication apparatus and a second wireless communication apparatus, said method comprising:
an acquisition step of causing device information concerning the second wireless communication apparatus to be acquired by the first wireless communication apparatus;
a storing step of storing configuration information, which is for the purpose of wireless communication, in a memory in correspondence with the device information concerning the second wireless communication apparatus;
a wireless communication step of executing communication wirelessly between the first wireless communication apparatus and the second wireless communication apparatus in accordance with the configuration information that has been stored in the memory at said storing step; and
an indication step of indicating to update or erase the configuration information that has been stored in the memory at said storage step in correspondence with the device information acquired by said acquisition step.

9. A method of setting up wireless communication in a communication apparatus for performing communication wirelessly with a wireless communication apparatus, said method comprising:
a requesting step of requesting configuration information of a wireless communication apparatus of a communicating party in a case where configuration information of the communicating party in wireless communication has not been stored in a memory for storing configuration information, which is for wireless communication, in correspondence with device information concerning the wireless communication apparatus;
a step of storing the configuration information, which has been transmitted from the communicating party, in the memory in response to the request at the requesting step;
a wireless communication control step of executing communication wirelessly with the wireless communication apparatus of the communicating party in accordance with the configuration information that has been stored in the memory;
a step of acquiring device information concerning the wireless communication apparatus of the communicating party from said communicating party; and
an indication step of indicating to update or erase the configuration information that has been stored in the memory in correspondence with the device information acquired at said acquisition step.

10. A method of controlling a wireless communication apparatus, comprising:
an acquisition step of acquiring device information concerning another wireless communication apparatus from this other wireless communication apparatus; and
an indication step of indicating to update or erase configuration information, which is for wireless communication, stored in a memory unit in correspondence with the device information acquired at said acquisition step.

11. A method of controlling a wireless communication apparatus, comprising:
a determination step of determining, based upon identification information of a communicating party acquired by wireless communication by a first scheme, whether configuration information, which is for communicating wirelessly with the communicating party by a second scheme, has been stored; and
a display step of presenting a display that conforms to the determination made at said determination step;
wherein said display step displays selectably at least any one of an indication to erase configuration information that corresponds to the communicating party, an indication to communicate wirelessly with the communicating party by the second scheme or an indication to update configuration information for communicating wirelessly with the communicating party by the second scheme.
